(19) United States
(12) Patent Application Publication
(10) Pub. No.: US 2024/0412051 A1
(43) Pub. Date: Dec. 12, 2024

(54) SPARSITY-AWARE NEURAL NETWORK PROCESSING

(71) Applicant: Microsoft Technology Licensing, LLC, Redmond, WA (US)

(72) Inventor: Zhuo RUAN, Redmond, WA (US)

(21) Appl. No.: 18/207,755

(22) Filed: Jun. 9, 2023

(51) Int. Cl. G06N 3/0495; G06T 1/20

(52) U.S. Cl. CPC G06N 3/0495; G06T 1/20

(57) ABSTRACT

Various embodiments discussed herein are directed to improving hardware consumption and computing performance by performing neural network operations on dense tensors using sparse value information from original tensors. Such dense tensors are condensed representations of other original tensors that include zeros or other sparse values. In order to perform these operations, particular embodiments provide an indication, via a binary map, of a position of where the sparse values and non-sparse values are in the original tensors. Particular embodiments additionally or alternatively determine shape data of the original tensors so that these operations are accurate.

### BACKGROUND

A neural network is typically modeled as a data flow graph (DFG), where each node in the DFG is an operator with one or more input and output tensors. A “tensor” (e.g., a vector) is a data structure that contains values representing the input, output, and/or transformations processed by the operator. Each edge of the DFG depicts the dependency between the operators. Neural Networks, such as Large Language Models (LLMs), are becoming exponentially large at a faster rate than certain hardware (e.g., CPU) performance capabilities. As these and other machine learning models increase in parameters or size, they have to perform a large quantity of operations (e.g., activation functions, dropout functions, etc.) on a large quantity of sparse values contained in tensors. “Sparse” values refer to empty or zero values that typically do not represent actual data. However, performing these operations on sparse values is costly in terms of hardware and computer resource consumption.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Various embodiments discussed herein are directed to performing neural network operations (e.g., matrix multiplication) on dense tensors using sparse value information from original tensors. Dense tensors are tensors where no zeros or other sparse values exist. Such dense tensors are condensed representations of the original tensors (e.g., sparse tensors) that include zeros or other sparse values. In order to perform these operations, particular embodiments provide an indication, via a binary map, of a position of where the sparse values and non-sparse values are in the original tensors. Particular embodiments additionally or alternatively determine shape data (e.g., the length of each axis) of the original tensors so that these operations are accurate. This improves hardware consumption and computing performance.

In an illustrative example, an original tensor may be a 3×3 matrix of values {[0,0,5], [20,5,0], [0, 66, 0]}. Particular embodiments, such as an AI hardware accelerator, may first derive a 1×4 dense tensor {5, 20, 5, 66}, which is a vector that represents each non-zero value in each set of the original tensor. That is, in the first bracket of the original tensor, there is only one non-zero value (5). In the second bracket of the original tensor, there are two non-zero values (20, 5). And in the third bracket, there is only one non-zero value (66). All such values are indicated in the dense tensor, whereas no zero value is indicated in the dense tensor. Using this illustration, the AI hardware accelerator computes shape data by determining that the original tensor is a 3×3 tensor {3,3}, which means that there are 3 rows and 3 columns of values.

Continuing with this illustration above, the AI hardware accelerator generates a binary map {[0,0.1], [1,1,0], [0,1,0]}. Each zero bit in the binary map indicates a corresponding zero value in the original tensor and each one bit in the binary map indicates a corresponding non-zero value in the original tensor. Compared with the original tensor—{[0,0,5], [20,5,0], [0, 66, 0]} —the binary map indicates that for the first set or bracket in the original tensor, there are two zero values in the first and second positions (indicated by two zero bits) and a non-zero value (i.e., a 5 value) in the third position, as indicated by a one bit. For the second set or bracket, there are two non-zero values (i.e., 20 and 5; both represented by a one bit) in the first two positions and a zero value in the third position. For the third set or bracket, there is a zero value in the first position, a non-zero value (i.e., 66) in the second position, and another zero value in the third position, indicated by 0, 1, 0 respectively.

Based on the shape data and the binary map, the AI hardware accelerator performs a neural network operation on the dense tensors. For example, a neural network node can derive a dot product output activation tensor based on multiplying the dense tensor with another dense tensor. Since there are no zero or sparse values in the dense tensors, the neural network node uses the shape data and binary map as input in order to determine the positions and quantity of zero values as indicated in the original tensor. In this way, the AI hardware accelerator can accurately perform the neural network operation.

Various embodiments of the present disclosure use a hardware accelerator to perform these neural network operations to improve hardware and computing resource consumption. For example, particular embodiments use an AI hardware accelerator, which can be circuitry integrated into a Graphics Processing Unit (GPU), a field programmable gate array (FPGA), an application-specific integrated circuit (ASIC), or a Tensor Processing Unit (TPU).

### BRIEF DESCRIPTION OF THE DRAWINGS

The present invention is described in detail below with reference to the attached drawing figures, wherein:

FIG. 1 is a block diagram depicting an example computing system architecture suitable for implementing some embodiments of the disclosure;

FIG. 2 is a schematic diagram illustrating an example architecture of a neural network, according to some embodiments;

FIG. 3 is a schematic diagram illustrating how a dense tensor is generated, according to some embodiments;

FIG. 4 is a schematic diagram illustrating how shape data is computed, according to some embodiments;

FIG. 5 is a schematic diagram illustrating how a binary map is generated, according to some embodiments;

FIG. 6 is a schematic diagram illustrating how matrix multiplication is performed using dense tensors, binary maps, and shape data, according to some embodiments;

FIG. 7 is a flow diagram of an example process for performing a machine learning model operation, according to some embodiments;

FIG. 8 is a block diagram illustrating circuitry and hardware architecture of an example hardware accelerator, according to some embodiments;

FIG. 9 is a block diagram illustrating an example operating environment suitable for implementing some embodiments of the disclosure; and

FIG. 10 is a block diagram of an example computing device suitable for use in implementing some embodiments described herein.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a stand-alone application, a service or hosted service (stand-alone or in combination with another hosted service), or a plug-in to another product, to name a few.

Some models are prone to employ many sparse tensors given the nature of their processing. Sparse tensors are tensors where the majority of values are zeros or are otherwise sparse. For example, natural language processing models are configured to process natural language as input and/or generate natural language at the output. However, tensors processed by these models tend to be very sparse. For instance, a document with natural language can be coded in a tensor where each cell or element represents whether a specific word in an entire natural language vocabulary is present (value of 1) or not present (value of zero). Given that there tends to be many words (and a lot of spaces in the document representing sparse values), a lot of the elements in tensors contain sparse values. In an illustrative example, a tensor representative of an entire language vocabulary may contain thousands of cells representing thousands of words. However the document may only contain a few 100 words. Accordingly, the tensor will be predominately populated by zeros for the spaces and words not contained in the document. This means that neural network operators are performing a lot of work on data that is not actual data.

Compounding the fact that many models are prone to work on sparse tensors by nature of their processing, these and other neural networks are also getting larger. Consequently, they must process even more sparse data. For example, some LLMs (e.g., Generative Pretrained Transformers (GPT) and Bidirectional Encoder Representations From Transformers (BERT)) have billions or trillions of parameters and hyperparameters. Thus, these models have to deal with a significantly high quantity of weights, coefficients, number of neurons, number of hidden layers, or the like. Accordingly, these neural networks have to perform a high quantity of operations on a high quantity of zeros or sparse tensors. For instance, a neural network operator may have to perform a massive quantity of tensor operations, such as activation functions (e.g., ReLU), matrix multiplication, normalization, dropout functions, or the like on many activation sparse tensors. Consequently, training and inference on these sparse values are costly both in terms of computational resource consumption and hardware consumption, as described in more detail below.

Neural network operations on sparse values are costly with respect to hardware consumption, such as storage, power, and input/output consumption. When a neural network operator multiplies a value by zero (a sparse value), for example, this is wasteful unnecessary work, since the output will always be zero. Given that models are increasing in size, this means that there is an unnecessarily large memory footprint because all of these zeros have to be stored in tensors over billions or trillions of parameters. Therefore, storage is unnecessarily consumed. Further, power is also unnecessarily consumed. During neural network operations, data has to be transferred from tensors in memory to a compute engine via computing device fabric or links. However, every time data is sent over the link, energy is expended. The more data that is sent over the link, the more energy will be expended. With respect to large models, a large quantity of zeros or other sparse values are transmitted across the link in many instances, which significantly increases the amount of energy consumed. Similarly, there is excess and unnecessary I/O when these sparse values are accessed from memory, which places unnecessary wear on storage access hardware components (e.g., a read/write head).

Neural network operations on sparse data are also costly with respect to computing resource consumption, such as latency and cycle processing. As described above, performing various computations, such as matrix multiplication, using zeroes is wasteful since any value multiplied by one is always zero. Yet neural network operators continue to perform many functions on many zeros or other sparse values. Consequently, prediction or inference latency is unnecessarily increased, especially with large models, such as LLMs. Accordingly, the delay in processing machine cycles is unnecessarily long, which means that the total time required for the fetching and execution of machine instructions (e.g., multiplication operations) is unnecessarily delayed.

Various embodiments of the present disclosure provide one or more technical solutions that have technical effects in light of these technical problems, as well as other problems, as described herein. In operation, various embodiments are directed to condensing tensors such that no zeros or sparse values exist, while at the same time providing an indication of a position of where the sparse values are in an original tensor so that accurate neural network operations can be performed. This improves hardware consumption and computing performance. Some embodiments additionally use a hardware accelerator (e.g., a Graphics Processing Unit (GPU)) to perform these neural network operations to improve hardware consumption and computing resource consumption.

In operation, a component, such as an AI hardware accelerator, derives a first tensor, which is a condensed representation of a second tensor, where the second tensor (e.g., a sparse tensor) includes one or more zero values and the first tensor does not include any zero values. For example, the second tensor may be a 3×3 matrix of values {[0,0,5], [20,5,0], [0, 66, 0]}, and particular embodiments may generate a 1×4 dense tensor (i.e., the first tensor), such as {5, 20, 5, 66}, which is a vector that represents each non-zero value in each set.

Some embodiments additionally or alternatively calculate shape data of the second tensor. The “shape” of a tensor refers to the length (i.e., quantity of values) in each axis (e.g., X, Y, or Z axis) of the tensor. For example, using the illustration above, particular embodiments calculate that the second tensor is a 3×3 tensor {3,3}, which means that there are 3 rows/X axis of values and 3 columns/Y axis of values.

Some embodiments additionally or alternatively generate a binary map, which is a data structure of one and zero bits only. Each zero bit in the binary map indicates a corresponding zero value in the second tensor and each one bit in the binary map indicates a corresponding non-zero value in the second tensor. For example, using the illustration above, a binary map that represents the second tensor may be as follows, {[0,0.1], [1,1,0], [0,1,0]}. Compared with the original non-condensed second tensor—{[0,0,5], [20,5,0], [0, 66, 0]}—the binary map indicates that for the first set or bracket in the second tensor, there are two zero values in the first and second positions and a non-zero value (i.e., a 5 value) in the third position. For the second set or bracket, there are two non-zero values (i.e., 20 and 5) in the first two positions and a zero value in the third position. For the third set or bracket, there is a zero value in the first position, a non-zero value (i.e., 66) in the second position, and another zero value in the third position. Based on the shape data and the binary map, some embodiments perform a neural network operation on the first tensor. For example, a neural network node can derive a dot product output activation tensor based on multiplying the first tensor with another dense tensor. To do this, the neural network node uses the shape data and binary map as input in order to determine the positions and quantity of zero values as originally indicated in the first non-dense tensor.

Some embodiments have the technical effect of reduced hardware consumption, such as computer storage reduction, power reduction, and I/O reduction. Instead of a network operator multiplying a value by 0, for example, particular embodiments multiply the value by non-zero values in dense tensors. Accordingly, one technical solution is the use of tensors that do not contain any sparse data and that are condensed representations of other tensors that contain sparse data. Accordingly, neural network operations do not perform any wasteful unnecessary work. This also means that there is not as big of a memory footprint because no zeros (or fewer zeros) or other sparse values are stored in these condensed tensors. Therefore, storage consumption is improved. Further, power and energy consumption is reduced. This is because condensed tensors are used, which means that no zeros (or fewer zeros) or sparse values are transmitted across the link in many instances, which significantly decreases the amount of energy consumed. For example, instead of transferring 1 MB of data across a link, only 0.75 MB of data is transferred. Similarly, there is reduced I/O because there are no or fewer sparse values accessed in storage, which places less wear on storage components, such as a read/write head. In a similar way, another technical solution is the use of shape data or their corresponding data structures, since they are typically 1-dimensional vectors, or otherwise contain very few values that indicate the size of a vector, thereby reducing storage and power consumption.

Some embodiments reduce or eliminate wear on certain hardware components, such as a Central Processing Unit (CPU). This is because particular embodiments employ the technical solution of a hardware accelerator to perform neural network operations, where the hardware accelerator is not a CPU. For example, an AI hardware accelerator can represent a Graphics Processing Unit (GPU), field programmable gate arrays (FPGA), application-specific integrated circuits (ASIC), or a Tensor Processing Unit (TPU). In other words, work which could have been done by CPU is offloaded to any of these AI hardware accelerator components, which eliminates usage and wear on the CPU so as to, for example, reduce the likelihood of hard errors (e.g., Clock Comparator (CC) damage, invalid registers, etc.), soft errors (e.g., degradation), terminating errors, or the like. The more a CPU is used, the greater likelihood of these errors occurring over time.

Some embodiments have the technical effect of reduced computing resource consumption, such as model inference latency and cycle processing. As described above, performing various computations, such as matrix multiplication (or any linear operations), using zeros is wasteful since, for example, any value multiplied by one is always zero. However, one technical solution is the use of a condensed tensor that does not include zeros or sparse values. This ensures that a neural network operator does not perform any (or a lot of) functions on zeros or other sparse values when making an inference (e.g., a confidence level classification or regression on a deployed model). Consequently, computing latency is reduced, especially with large models. In this way, a quantity of processing cycles are reduced, which means that the total time required for the fetching and execution of machine instructions is reduced when performing an inference for a model.

Another technical solution with respect to latency and cycle processing (as well as memory consumption) is the usage of a binary map. A binary map contains only binary codes or values. A “binary code” as described herein is a base-two number representation that only has two symbols, 0 and 1, which are bits. This is contrasted with other numbers, such as integers, floats, or decimals, which are base-ten representations where there are 10 symbols (0, 1, 2, 3, 4, 5, 6, 7, 8, and 9).

Binary values maximize information carried by each bit, which allows for more compact representations in memory compared to real-valued descriptors (e.g., integers), which are stored in memory as groups of bits (e.g., 32) for a given real value as opposed to single bits for binary values. When data sets are extremely large, minimizing the storage overhead is crucial, which binary values allow. A decimal number or integer can occupy one byte (8 bits) or half a byte for each digit (e.g., positive numbers from 0 to 255) since there are 10 possible values for a digit (0-9), indicative of a base 10 representation. Conversely, binary values are memory storage efficient in that that they are only base-2 (0 or 1) representations. Effectively, binary values take only 1 bit (⅛th of a byte) to store a binary value. Accordingly, more values or data can be stored to the same amount of space using binary values, as opposed to integers, floating point values, decimal values, or any other non-binary values. Moreover, binary values allow for improved latency, such as reduced model inference latency, because binary values are what computers natively process. However, if values are stored as integers, floats, or any other non-binary numbers, the computer has to employ complex decoders to convert the non-binary numbers into binary, which increases latency.

Another technical solution and improvement with respect to latency and cycle processing is the usage of a hardware accelerator in some embodiments. CPUs typically perform poorly when it comes to neural network performance, especially when neural networks are large. There are usually too many parameters that have to be processed in parallel for any CPU or series of CPU cores to handle at inference time. Consequently, CPUs negatively impact latency with respect to inference predictions. However, various embodiments of the present disclosure employ a technical solution of a hardware accelerator, which does not include a CPU. Various AI hardware accelerators, such as FPGAs, ASICs, or a TPUs include circuitry that is fully capable of efficiently processing large amounts of data in parallel for neural network operations, including trillions of parameters in LLMs so as to reduce the latency with respect to inference relative to the CPU.

Some embodiments of the present disclosure also improve existing technologies with respect to neural network processing on sparse data. For example, instead of using a condensed tensor of non-zero values, some technologies only use original sparse tensors and shut down a compute engine over zeroes (i.e., they “skip” the zeros) to save on power through clock-gating. However, this method does not improve computing resource consumption in terms of latency. Inference still takes the same amount of clock cycles if not more because the skip operation is still performed for each zero. Various embodiments of the present disclosure improve these technologies because they completely avoid computations and operations on zeros by deriving a condensed tensor of non-zero values and performing operations on the condensed tensor only. Consequently, these embodiments perform a significantly smaller quantity of computations so as to shorten inference latency, while at the same time saving on power, as described herein.

Some embodiments also improve Compressed Sparse Row (CSR or Yale format) technologies. CSR represents a matrix M by three (one-dimensional) arrays, which respectively contain non-zero values, the extents of rows, and column indices. However, these technologies requires complex hardware design to decode the values. For example, these values may contain integers, floats, or other non-binary values that must be converted to binary values for computations, which increases latency. However, various embodiments of the present disclosure improve these technologies by using a binary map. Such binary map contains binary codes (0 and 1) for location recording and indicates whether a respective value in a tensor is a zero value (via a 0 bit) or a non-zero value (via a 1 bit). This enables easier hardware design and saves on compute power because there are no complex decoders needed to translate non-binary values to binary, since the format of the binary map is already in binary. This helps propagate sparse shape information from one layer to the next in neural networks.

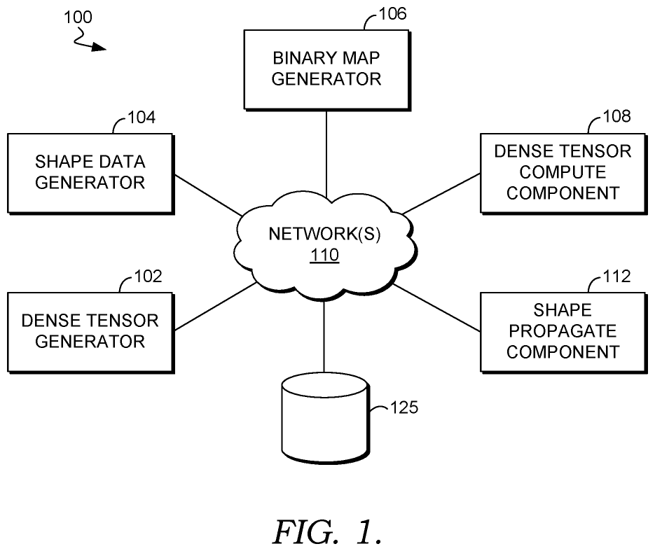

Turning now to FIG. 1, a block diagram is provided showing aspects of an example computing system architecture suitable for implementing some embodiments of the disclosure and designated generally as system 100. The system 100 represents only one example of a suitable computing system architecture. Other arrangements and elements can be used in addition to or instead of those shown, and some elements may be omitted altogether for the sake of clarity. Further, as with system 100, many of the elements described herein are functional entities that are implemented as discrete or distributed components or in conjunction with other components, and in any suitable combination and location according to various embodiments.

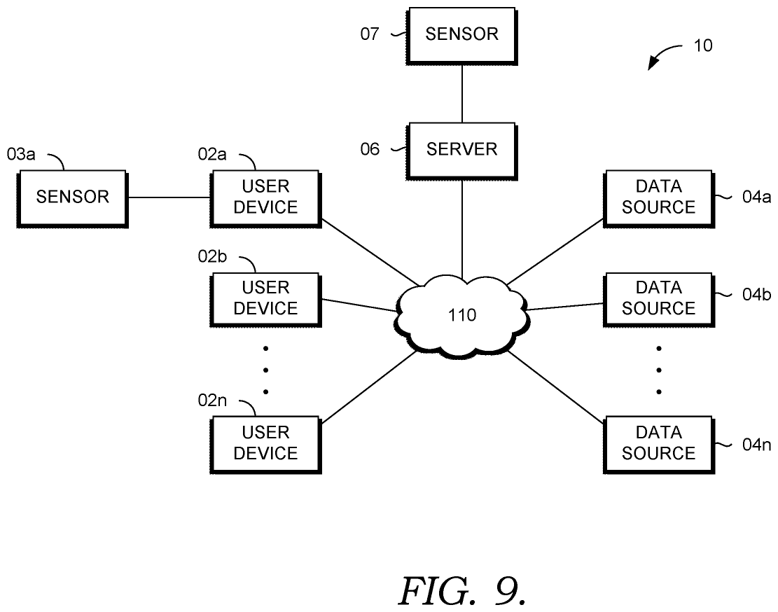

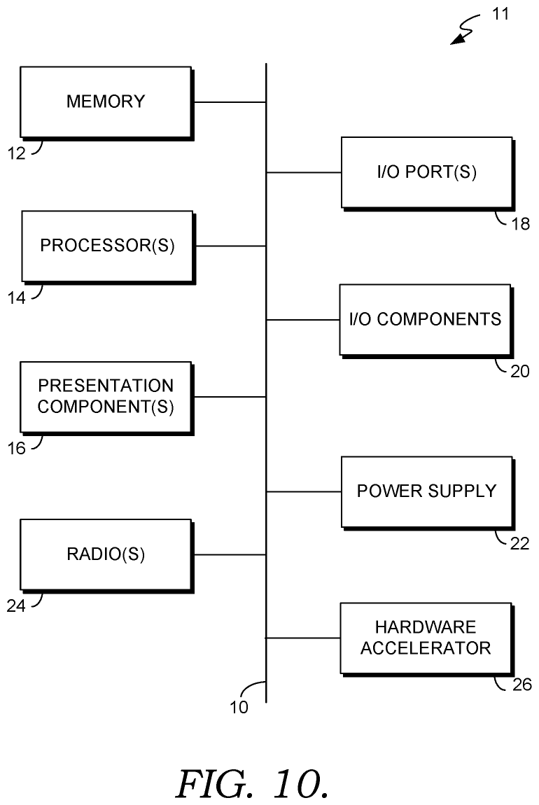

Example system 100 includes network(s) 110, which is described in connection to FIG. 9, and which communicatively couples components of system 100 including a dense tensor generator 102, a shape data generator 104, a binary map generator 106, a dense tensor compute component 108, a shape propagate component 112, and storage 125. The system 100 is generally responsible for condensing tensors such that no zeros or sparse data exists, while at the same time providing an indication of a position of where the sparse values are in an original tensor so that accurate neural network operations can be performed to improve hardware consumption and computing performance. In some embodiments, these components in the system 100 are embodied as a set of hardware circuitry components (e.g., a hardware accelerator), compiled computer instructions or functions, program modules, computer software services, a combination thereof, or an arrangement of processes carried out on one or more computer systems, such as computing device 11 described in connection to FIG. 10, and the user device 02a and/or the server 06 of FIG. 9, for example.

In some embodiments, the functions performed by components of system 100 are associated with one or more personal assistant applications, services, or routines. In particular, such applications, services, or routines can operate on one or more user devices (such as user device 02a of FIG. 9), servers (such as server 06 of FIG. 9), can be distributed across one or more user devices and servers, or be implemented in the cloud. Moreover, in some embodiments, these components of system 100 are distributed across a network, including one or more servers (such as server 06 of FIG. 9) and client devices (such as user device 02a of FIG. 9), in the cloud, or reside on a user device, such as user device 02a of FIG. 9. Moreover, these components, functions performed by these components, or services carried out by these components are implemented at appropriate abstraction layer(s) such as the operating system layer, application layer, and/or hardware layer of the computing system(s). Alternatively, or in addition, in some embodiments, the functionality of these components and/or the embodiments described herein are performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), and Complex Programmable Logic Devices (CPLDs). Additionally, although functionality is described herein with regards to specific components shown in example system 100, it is contemplated that in some embodiments functionality of these components are shared or distributed across other components.

In some embodiments, each of the active components of the system 100 (i.e., the dense tensor generator 102, the shape data generator 104, the binary map generator 106, the dense tensor compute engine 108, and the shape propagate component 112) perform their functionality at runtime or after a machine learning model has been deployed. For example, at the application layer, there may be a user request to make a prediction, such as predicting generative text, classifying a photograph, or the like. Responsive to receiving such request, a CPU may forward to the request to the system 100 for processing. After the components of the system 100 perform their functionality, one or more components (e.g., the dense tensor compute component 108) can pass the results/predictions back to the CPU, which then causes the predictions to be presented to a user device. However, it is understood that at least some of the components (e.g., the dense tensor generator 102) can additionally or alternatively perform their functionality in training, testing, fine-tuning, and/or offline environments.

Continuing with FIG. 1, the dense tensor generator 102 is generally responsible for generating one or more dense tensors or other data structures. For example, a machine learning model input may be a prompt (e.g., a question) and/or a document associated with a request to generate a text summary of the document. Particular embodiments may then generate a tensor for a certain neural network node that represents whether a certain word is present in the document and the dense tensor generator 102 may generate a dense tensor representing such tensor.

A “dense tensor” is a tensor that contains no sparse values. Dense tensors contain all non-sparse values. In various embodiments, a dense tensor is a condensed or compressed version of another tensor (referred to herein as a “non-dense” tensor) that contains one or more sparse values. For example, a dense tensor can be a condensed version of a sparse tensor. In some embodiments, the dense tensor generator 102 generates dense tensors only for those tensors that are sparse tensors. A “sparse tensor” is a tensor that contains 50% or more of sparse values. However, a sparse tensor can refer to any sparse value threshold. For example, a sparse tensor may not qualify as a sparse tensor unless it contains 70% or 80% of sparse values. The dense tensor generator 102 may only generate dense tensors for sparse tensors because there is a computing cost (e.g., in terms of memory consumption and compute latency) for generating dense tensors for every single tensor.

In some embodiments, the dense tensor generator 102 generates dense tensors by transferring all spare values from the non-dense tensor to a dense tensor while maintaining the position (e.g., X, Y matrix position) data for the non-zero data. For example, for a 3×3 matrix (i.e., the non-dense tensor), where the top row contains the non-zero values of 1, 2, and 3, the dense tensor generator 102 generates a dense tensor by generating a top row of the non-zero values of 1, 2, and 3 in the same position. In other words, a dense tensor is identical to a non-dense tensor both in terms of values and position of the values, except that the zeros have been extracted or removed in dense tensors.

The shape data generator 104 is generally responsible for computing a shape of the non-dense tensor. For example, if the original non-dense tensor was a 3×3 matrix, the shape of such matrix is 3×3-three rows by three columns. In other words, shape refers to the length or number of elements (e.g., cells) in each axis or dimension. In an illustrative example, the shape data generator 104 calculates the shape data by calling or performing a function that returns a vector with each index having the number of corresponding elements.

The binary map generator 106 is generally responsible for generating a binary map. A “binary map” is a data structure (e.g., another tensor) that only contains or consists of binary codes—0 or 1 bits. A binary map indicates the position of all values in the non-dense tensor and records whether a corresponding value is a sparse value in the non-dense tensor (with a 0 bit) and whether a corresponding value is a non-sparse value (with a 1 bit). In this way, particular embodiments can quickly assess whether and where the non-dense tensor contained sparse values and non-sparse values, as described in more detail below.

The shape propagate component 112 is generally responsible for taking, as input, the shape data generated by the shape data generator 104, the binary map generated by the binary map generator 106, and/or an original output (e.g., sparse) tensor, and generates the sparse location information for use in generating the final output dense tensor (which is performed by the dense tensor compute component 108). For example, the “sparse location information” can include an output binary map that indicates where the sparse data is located for the output dense tensor (e.g., an activation output dense tensor) generated by the dense tensor compute component 108. Such output binary map indicates where exactly the zero or other sparse values are located since the final output dense tensor does not contain zeros.

The dense tensor compute component 108 is generally responsible for performing one or more machine learning operations on the dense tensors generated by the dense tensor generator 102, instead of the non-dense tensors. For example, the dense tensor compute component 108 performs matrix multiplication (e.g., to multiply weight matrices by the activation matrices), activation functions, normalization, RELU, etc. In some embodiments, the dense tensor compute component 108 takes, as input, the output binary tensor generated by the shape propagate component 112, as well as the shape data, in order to perform these operations since the output dense tensors have no sparse values in them. In an illustrative example, the dense tensor compute component 108 can generate a final activation output tensor, such as a dot product tensor. That is, the dense tensor compute component 108 can take a first dense tensor and multiply it by a second dense tensor doing matrix multiplication to come up with a dense tensor output. However, in order to get this final dense tensor output, in some embodiments, the dense tensor compute component 108 needs to know exactly where the sparse values are located at. Such information is derived from the output binary map (generated by the shape propagate component 112) as well as final shape data.

Example system 100 also includes storage 125. Storage 125 generally stores information including data, computer instructions (for example, software program instructions, routines, or services), data structures, and/or models used in embodiments of the technologies described herein. In some embodiments, storage 125 represents any suitable data repository or device, such as a database, a data warehouse, RAM, cache, disk, RAID, and/or a storage network (e.g., Storage Area Network (SAN)). In some embodiments, storage 125 includes data records (e.g., database rows) that contain any suitable information described herein. In some embodiments, each record is called or requested and returned, over the computer network(s) 110, depending on the component needing it, as described herein.

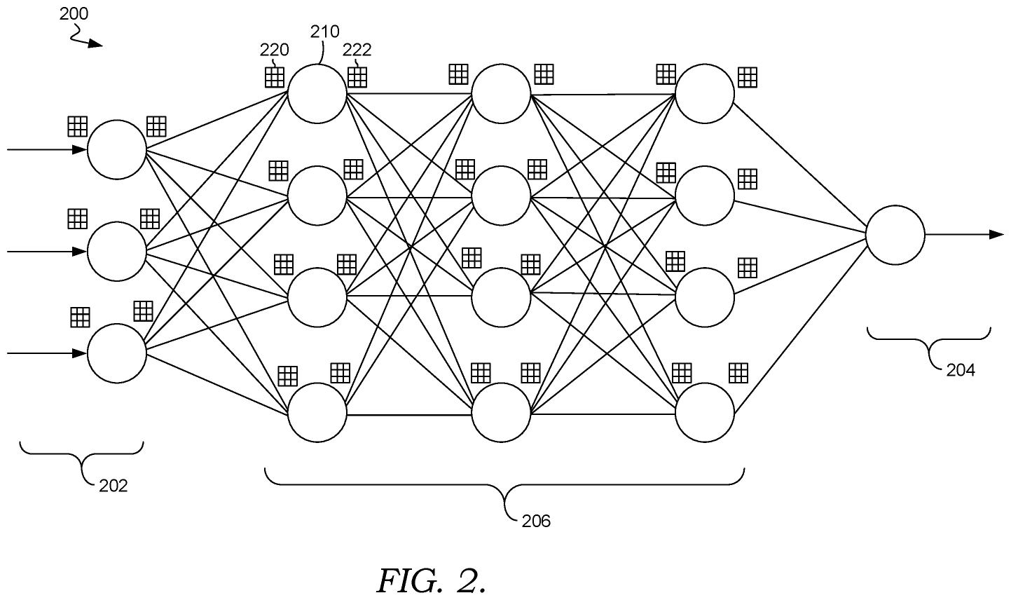

FIG. 2 is a schematic diagram illustrating an example architecture of a neural network 200, according to some embodiments. Neural network 200 may represent any suitable neural network, such as a LLM (e.g., a GPT or BERT), a convolutional network networks (CNN), recurrent network networks (RNNs) (e.g., a long short term memory (LSTM)), or the like. It is also understood that although machine learning model represented in FIG. 2 is a neural network 200, any suitable machine learning model can alternatively or additionally be used in conjunction with FIG. 1 or any other functionality described herein where models perform work on sparse data contained in particular data structures.

In an illustrative example, additional or alternative model functionality can be represented, such as supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial lest squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or any suitable form of machine learning algorithm.

Neural network 200 includes an input layer 202, an output layer 204 and one or more hidden layers 206. Input layer 202 is the first layer of the neural network 200. Input layer 202 receives input data, such as natural language documents, prompts, questions/queries, image data, speech data, etc. Output layer 204 is the last layer of neural network 200. Output layer 204 generates one or more inferences in the form of clustering, regression, classifications, or the like, which can either be hard classification (e.g., object is an “apple”) or soft probabilities (e.g., 50% likely that an object refers to an apple). Neural network 200 may include any number of hidden layers 206. Hidden layers 206 are intermediate layers in neural network 200 that perform various operations. Neural network 200 may include additional or fewer layers than the example shown in FIG. 2. Each layer in the neural network 200 includes a plurality of nodes. One example of a node is node 210.

As illustrated in FIG. 2, each node in FIG. 2A, such as node 210, is associated with or includes one or more activation tensors, such as input tensors (e.g., 220), output tensors (e.g., 222), and/or intermediate tensors. In some embodiments, such tensors represents the tensors or other data structures generated by the dense tensor generator 102, the shape data generator 104, the binary map generator 106, and/or the shape propagate component 112 of FIG. 1. An “activation tensor” is a tensor that is an input, intermediate, and/or output to at least one neural network layer (e.g., as modeled going from left to right). This is different than a weight tensor, where weight tensors are modeled as flowing upward (not being actual inputs or outputs). As described in more detail herein, sparsity (also called “activation sparsity”) may be more of a concern within activation tensors and not weight tensors, since weight tensors are typically not associated with any sparse values and are permanently set when a model is trained, as opposed to activation tensors. In other words activation tensors represent some form of the neural network input, such as a document, photograph, prompt, or the like, whereas a weight tensor represents the weight values indicating node activation/inhibition values.

Each node in the network 200 may also be associated with or include and/or one or more weight tensors, which include weight values. A “weight” in the context of machine learning may represent the importance or significance of a feature or feature value for prediction. For example, each feature may be associated with an integer or other real number where the higher the real number, the more significant the feature is for its prediction. In one or more embodiments, a weight in a neural network represents the strength of a connection between nodes or neurons from one layer (an input) to the next layer (a hidden or output layer). A weight of 0 may mean that the input will not change the output, whereas a weight higher than 0 changes the output. The higher the value of the input or the closer the value is to 1, the more the output will change or increase. Likewise, there can be negative weights. Negative weights may proportionately reduce the value of the output. For instance, the more the value of the input increases, the more the value of the output decreases. Negative weights may contribute to negative scores.

Each node of the neural network 200 may additionally perform one or more functions using the activation tensors and weight tensors, such as activation functions, matrix multiplication, normalization, or the like. In some embodiments, the nodes in the neural network 200 are fully connected or partially connected. Continuing with FIG. 2, each node may process an input using activation tensors and weight tensors. For example, the neural network 200 may first receive an entire input, such as a natural language document or a prompt. In some embodiments, the neural network 200 first performs pre-processing, such as encoding or converting such input into machine-readable indicia representing the entire input (e.g., a tensor representing a document). Responsively, the node 210 may then receive an input tensor 220, which may, for example, represent whether one or more features (e.g., particular words) are present in the input. In some embodiments, the input tensor 220 is an N-dimensional tensor, where N can be greater than or equal to one. In some embodiments, an input tensor represents the input data of neural network 200 if the node is in the input layer 202. In some embodiments, the input tensor 220 is also the output of another node in the preceding layer. In some embodiments after a node, such as the node 210, performs an operation using the input tensor 220, it generates an output tensor 222, which is then passed to the other neurons in the hidden layer 200. The output tensor 222 represents the output processed by the node 210. For example, the output tensor 222 may be a matrix representing the product of matrix multiplication or a matrix indicating whether one or more words were found to be present in a document. In various embodiments, the output tensor 222 represents an input of another node in the succeeding layer (i.e., the output layer).

In some embodiments, node 210 applies a weight tensor to the input tensor 220 via a linear operation (e.g., matrix multiplication, addition, scaling, biasing, or convolution). All other nodes in the neural network may perform identical functionality. In some embodiments, the result of the linear operation is processed by a non-linear activation, such as a step function, a sigmoid function, a hyperbolic tangent function (tan h), and rectified linear unit functions (ReLU) or the like. The result of the activation or other operation is an output tensor 222 that is sent to a subsequent connected node that is in the next layer of neural network 200. The subsequent node uses the output tensor 222 as the input activation tensor to another node.

Each of the functions in the neural network 200 may be associated with different coefficients (e.g., weights and kernel coefficients) that are adjustable during training. For example, after preprocessing (e.g., normalization, data wrangling, feature scaling and extraction) in various embodiments, the neural network 200 is trained using one or more data sets of the preprocessed training data inputs in order to make acceptable loss training predictions at the appropriate weights to set the weight tensors. This will help later at deployment time to make correct inference predictions. In one or more embodiments, learning or training includes minimizing a loss function between the target variable (for example, an incorrect prediction that a phrase has semantic meaning X) and the actual predicted variable (for example, a correct prediction that the phrase has semantic meaning Y). Based on the loss determined by a loss function (for example, Mean Squared Error Loss (MSEL), cross-entropy loss, etc.), the loss function learns to reduce the error in prediction over multiple epochs or training sessions so that the neural network 200 learns which features and weights are indicative of the correct inferences, given the inputs. Accordingly, it is desirable to arrive as close to 100% confidence in a particular classification or inference as much as possible so as to reduce the prediction error. In an illustrative example, the neural network 200 learns that for a given set of character sequences, the correct meaning or the text to be generated next is Y.

Subsequent to a first round/epoch of training, the neural network 200 makes predictions with a particular weight value, which may or may not be at acceptable loss function levels. For example, the neural network 200 may process the pre-processed training data inputs a second time to make another pass of predictions. This process may then be repeated over multiple iterations or epochs until the weight values in the weight tensors are learned for optimal or correct predicted values (for example, by maximizing rewards and minimizing losses) and/or the loss function reduces the error in prediction to acceptable levels of confidence.

In some embodiments, training the neural network 200 includes pre-training a model, such as a LLM. For example, an encoder (or decoder) of a transformer can learn what language and context for a word is in pre-training by training on two unsupervised tasks, Masked Language Modeling (MLM) and Next Sentence Prediction (NSP), simultaneously or at the same time. In terms of the inputs and outputs, at pre-training, the natural language inputs may be various historical documents, such as text books, journals, periodicals in order to output the predicted natural language characters in (not make the predictions at runtime at this point). The encoder block takes in a sentence, paragraph, or sequence, with random words being replaced with masks. The goal is to output the value or meaning of the masked tokens. For example, with respect to MLM, if a line reads, “please [MASK] this document promptly,” the prediction for the “mask” value is “send.” This helps the encoder block understand the bidirectional context in a sentence, paragraph, or line at a document. In the case of NSP, the encoder takes, as input, two or more elements, such as sentences, lines, or paragraphs and determines, for example, if a second line in a document actually follows (for example, is directly below) a first line in the document. This helps the encoder block understand the context across all the elements of a document, not just within a single element. Using both of these together, the encoder block derives a good understanding of natural language.

In pre-training, the output is typically a binary value C (for NSP) and various word vectors (for MLM). With training, a loss (for example, cross entropy loss) is minimized. In some embodiments, all the feature vectors or tensors are of the same size and are generated simultaneously. As such, each word vector can be passed to a fully connected layered output with the same number of neurons equal to the same number of tokens in the vocabulary.

In some embodiments, once pre-training is performed, the encoder block is tested on very specific tasks in the fine-tuning phase or prompt engineering, such as Question Answering, modified NSP or MLM, and then deployed in preparation to analyze inputs at runtime. Accordingly certain embodiments do not have to change the model for fine-tuning by changing the input layer and the output layer or otherwise adjusting the weights of the neural network node connections, as would otherwise be required by fine-tuning.

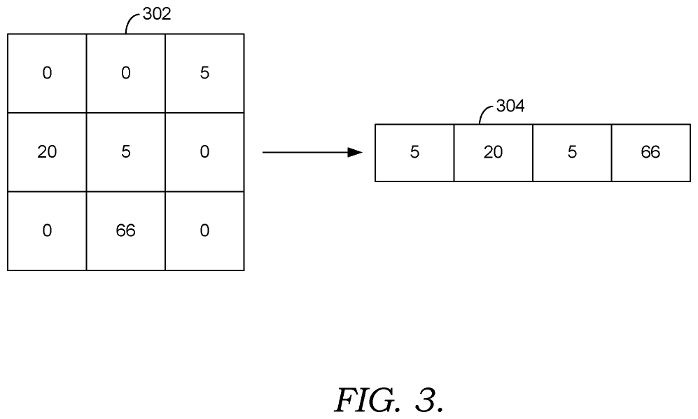

FIG. 3 is a schematic diagram illustrating how a dense tensor 304 is generated, according to some embodiments. In some embodiments, the dense tensor generator 102 generates the dense tensor 304, as described with respect to FIG. 1. In some embodiments, the tensors 302 and/or 304 represent the input or output tensors 220 and/or 222 of FIG. 2 (and/or any other input, intermediate, or output tensors described herein).

The non-dense tensor 302 includes is a matrix of various sparse values and non-sparse values. Particular embodiments generate the dense tensor 304 by transferring or extracting position information along with all non-zero values in the tensor 302 and populating the non-zero values in the tensor 304 according to the position information. The dense tensor 304 is a 1×4 vector of contiguous non-zero values. In various embodiments, position information of all the non-values in the tensor 304 is generated and/or accessed via one or more indices. For example, an index can be built for each field or cell in the dense tensor 304 to indicate the field address (e.g., row ID and column ID) as found in the original non-dense tensor 302. For example, for value 5, and index can built, which indicates that value 5 belongs to row 1 and column 3 of the non-dense tensor 302.

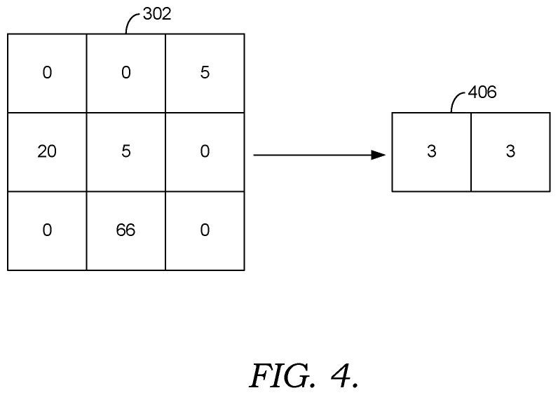

FIG. 4 is a schematic diagram illustrating how shape data is computed, according to some embodiments. In some embodiments, the shape data generator 104 generates the shape tensor 406, as described with respect to FIG. 1. In some embodiments, the shape tensor 406 is additionally or alternatively included in the input or output tensors 220 and/or 222 of FIG. 2 (and/or any other input or output tensors represented in FIG. 2).

Particular embodiments generate the shape tensor 406 by calculating the length of each axis of the non-dense tensor 302. For example, the shape data generator 104 can iterate or count each entry within the non-dense tensor 302 and return a value of number of columns (3) and number of rows (3) that makeup the non-dense tensor 302. With respect to FIG. 4, the length of the non-dense tensor 302 is 3λ3, which is indicated in the shape tensor 406 (i.e., [3, 3]). The shape tensor 406 is a vector of contiguous values that indicates how many rows (3) the non-dense tensor 302 and how many columns (3) the non-dense tensor 302 has. In some embodiments, the shape data generator 104 computes shape data via accessing one or more indices on the non-dense tensor 302. For example, the shape data generator 104 can iterate though each index until it computes the shape.

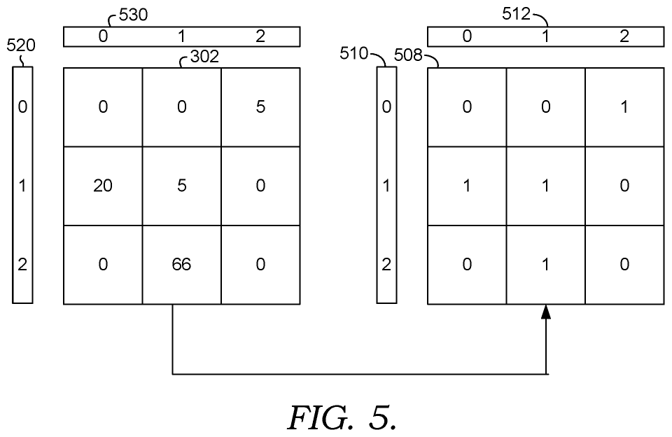

FIG. 5 is a schematic diagram illustrating how a binary map 508 is generated, according to some embodiments. In some embodiments, the binary map generator 106 generates the binary map 508, as described with respect to FIG. 1. In some embodiments, the binary map 508 is additionally or alternatively included in the input or output tensors 220 and/or 222 of FIG. 2 (and/or any other input, intermediate, or output tensors described herein).

Particular embodiments generate the binary map 508 by recording position information of all values in the non-dense tensor 302 and generating binary codes to indicate whether the corresponding value at the corresponding position is a sparse value (bit 0) or a non-sparse value (bit 1). For example, as illustrated in FIG. 5, for the top first row of the non-dense tensor 302 (i.e., values 0, 0, 5), the first two zero values are sparse values and the last 5 value is a non-sparse value. Accordingly, particular embodiments encode a corresponding respective row of 0, 0, 1, as illustrated in the binary map 508 in the same location. This indicates that the first two values of this row in the non-dense tensor 302 are sparse and the last value (i.e., the 5 value) is not sparse. This same process is repeated for each row and/or column. For example, for the middle row of the non-dense tensor 302 (i.e., values 20, 5, 0), the first two zero values are non-sparse values and the last 0 value is a sparse value. Accordingly, particular embodiments encode a corresponding respective row of 1, 1, 0 in the binary map 508 in the same location. This indicates that the first two values of this row in the non-dense tensor 302 are not sparse and the last value (i.e., the 0 value) is sparse.

In some embodiments, the position information in the non-dense tensor 302 and/or the binary map 508 is determined or accessed via the indices 520, 530, 510, and/or 512. For example, particular embodiments may build the row indices 510 and column indices 512 for the binary map 512, as illustrated in FIG. 5. Particular embodiments may additionally or alternatively build the row indices 520 and the column indices 530 for the non-dense tensor 302. The number in the row indices indicates which row a value is in and the number in the column indices indicates which column a value is in. In this way a particular value and its position (i.e., its row/column address) can be extracted from a particular address of the non-dense tensor 302 and placed in a corresponding address in the binary map 512. For example, in embodiments where elements or values are accessed first by row number, then column number, for the indices, [0, 2] of the non-dense tensor 302 (referring to row 0 and column 2), the entry or value in the non-dense tensor 302 is 5. Some embodiments then responsively use the indices 510 and 512 to place a “1” value in the exact same address/entry within the binary map 508, as illustrated in FIG. 5—that is via indices [0, 2].

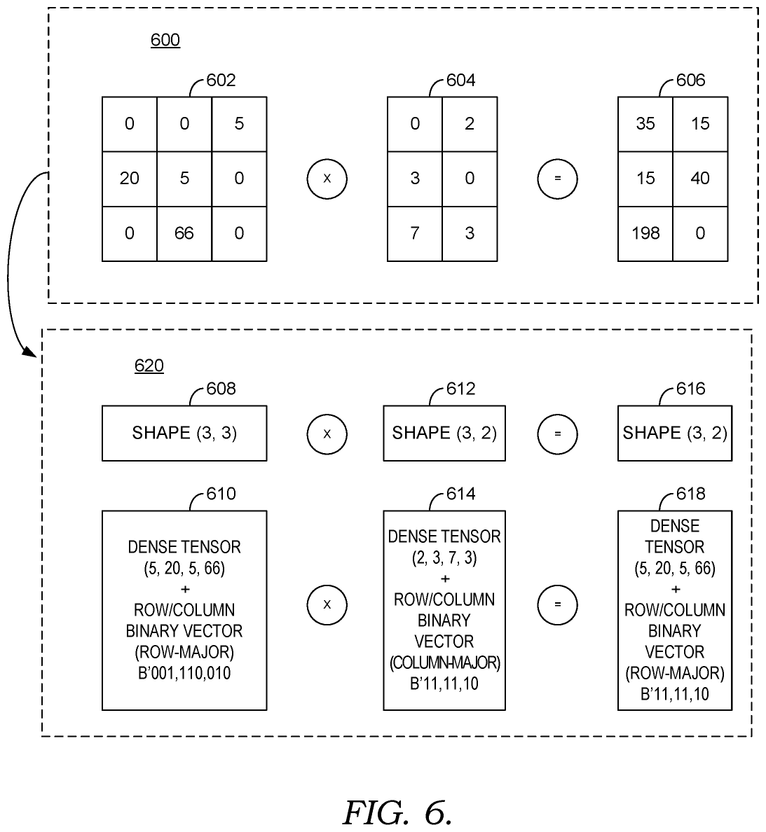

FIG. 6 is a schematic diagram illustrating how matrix multiplication is performed using dense tensors, binary maps, and shape data, according to some embodiments. The sequence 600 represents sparse tensor matrix multiplication computations that typical neural networks perform. That is, the sparse tensor 602 is multiplied by the tensor 604, which equals the output tensor 606. In some embodiments, the tensors 602, 604, 608, 610, 612, and/or 614 represent the activation input tensor(s) 220 of FIG. 2. In some embodiments, the tensors 606, 616, and/or 618 represent the activation output tensor(s) 222 of FIG. 2. In some embodiments, the tensors 604, 612, and/or 614 represent weight tensors instead of activation tensors.

In various embodiments of the present disclosure, the sequence 620 is additionally or alternatively performed relative to the sequence 600. For example, at a first time, particular embodiments (e.g., the dense tensor generator 102) convert the sparse tensor 602 into a dense tensor {5, 20, 5, 66} as illustrated in 610 (e.g., a particular data structure). At another time, particular embodiments (e.g., the shape data generator 104) calculate the shape data of the tensor 602, where the shape is 3×3 and the output is a vector 608. Particular embodiments (e.g., the binary map generator 106) additionally generate a binary map 001, 110, 010, which are bits that represent the zero values and the non-zero values in the sparse tensor 602. Such binary map is also stored to 610. In some embodiments, in order to generate the binary map, particular embodiments use the shape vector 608, the dense tensor in 610, and/or the sparse tensor 602 as one or more indices.

This process is repeated for the second sparse tensor 604. That is, particular embodiments convert the sparse tensor 604 into a dense tensor {2, 3, 7, 3} as illustrated in 614 (e.g., a particular data structure, such as a tensor). At another time, particular embodiments calculate the shape data of the tensor 604, where the output is a shape vector 612. Particular embodiments additionally generate a binary map 011, 101 which are bits that represent the zero values and the non-zero values in the tensor 604. That is, for example, for the first column 0, 3, 7 in the sparsity tensor 604, the first element is a zero/sparse value that is represented by a “0” bit in the binary map, the second element is a “3” value that is represented by a “1” bit in the binary map, and the third element is a “7” value that is represented as a “1” bit in the binary map (i.e., the binary map for this column is 011). Such binary map is also stored to 614.

Particular embodiments (e.g., the shape propagate component 112) multiply the shape vectors 608 and 612 to arrive at a final product shape vector 616. Additionally or alternatively, particular embodiments (e.g., the shape propagate component 112) multiply the binary map 001, 110, and 010 as indicated in 610 with the binary map 011, 101 as indicated in 614 to arrive at the binary map 11, 11, 10, as indicated in 618. In order to arrive at the product result of the dense tensors in 618, in various embodiments, the dense tensor compute component 108 uses one or more indices (or otherwise takes as input), the binary map 11, 11, and 10 as well as the shape vector 616 to generate the dense tensor in 618. That is, some embodiments (e.g., the dense tensor compute component 108) multiply the dense tensor {5, 20, 5, 66} by the dense tensor {2, 3, 7, 3} to arrive at the dense tensor indicated in 618 using the shape 616 as well as the binary map indicated in 618.

The binary map 11, 11, 10 in 618 represents the zero values and non-zero values at the corresponding positions in the output tensor 606. For example, the first row in the output tensor 606 includes values 35 and 15, which are respectively represented by a 1 bit in the binary map (i.e., “11”). The second row in the output tensor 606 includes values 15 and 40, which are respectively represented by another set of 1 bits in the binary map (i.e., another “11”). The third row in the output tensor includes values 198 and 0, which is respectively represented by a 1 bit and a 0 (i.e., “10”). Therefore, the final binary map is 11, 11, 10.

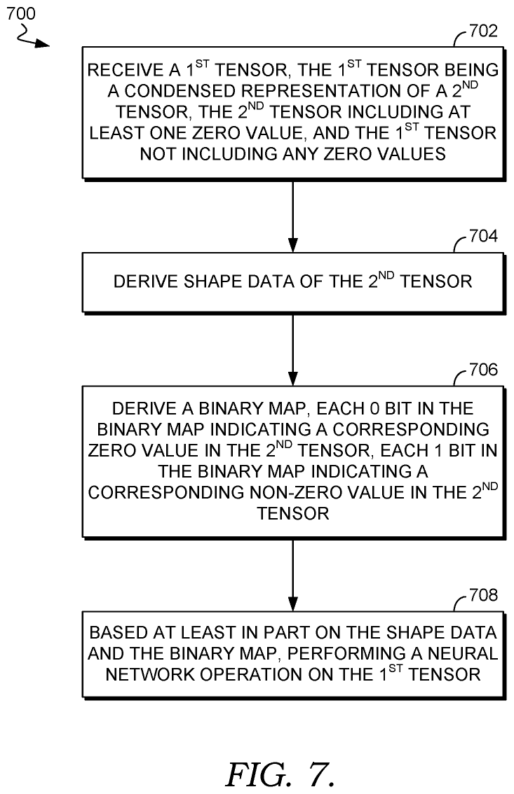

FIG. 7 is a flow diagram of an example process 700 for performing a machine learning model operation, according to some embodiments. The process 700 (and/or any of the functionality described herein) may be performed by processing logic that comprises hardware (for example, circuitry, dedicated logic, programmable logic, microcode, and the like), software (for example, instructions run on a processor to perform hardware simulation), firmware, or a combination thereof. Although particular blocks described in this disclosure are referenced in a particular order at a particular quantity, it is understood that any block may occur substantially parallel with or before or after any other block. Further, more (or fewer) blocks may exist than illustrated. Added blocks may include blocks that embody any functionality described herein (for example, as described with respect to FIGS. 1-6). The computer-implemented method, the system (that includes at least one computing device having at least one processor and at least one computer readable storage medium), and/or the computer readable medium as described herein may perform or be caused to perform the process 700 or any other functionality described herein.

It is understood that in some embodiments, a hardware accelerator (e.g., an AI hardware accelerator) performs the process 700. In other embodiments, however, any non-hardware accelerator can perform the process 700. Although in some instances a CPU can be a hardware accelerator, in other instances they are not included in a hardware accelerator. As such, in some embodiments, a CPU performs the process 700 by executing computer-readable instructions stored in memory/storage. In some embodiments, the hardware accelerator includes one or more circuitry components, which may be included in one of: a Graphics Processing Unit (GPU), field programmable gate arrays (FPGA), application-specific integrated circuits (ASIC), or a Tensor Processing Unit (TPU), where the hardware accelerator excludes a Central Processing Unit (CPU). An “AI accelerator” is a high-performance parallel computation machine that is specifically designed for the efficient processing of machine learning/AI workloads, such as neural networks.

Per block 702, some embodiments receive a first tensor, where the first tensor is a condensed representation (e.g., a dense tensor) of a second tensor (e.g., a sparse tensor). The second tensor includes at least one zero value and the first tensor does not include any zero values. For example, referring back to FIG. 3, particular embodiments receive the dense tensor 304, which is a compressed representation of the sparse tensor 302. Some embodiments additionally receive the second tensor (which can also be referred to as a first tensor). Some embodiments additionally generate the first tensor as described, for example, with respect to the dense tensor generator 102 of FIG. 1.

A “tensor” as described herein is a data structure of any N dimensions that holds values and which machine learning models perform work on. For example, a tensor can be a scalar, vector, matrix, a cube, or the like. The dimensionality of a tensor is typically referred to as a “rank.” A 1D (or rank 1) tensor, for example, refers to an array or vector. A 2D (or rank 2 tensor) is a 2-dimensional array or matrix (e.g., as illustrated in by the tensor 302 in FIG. 3). A 3D (or rank 3 tensor) is a cube, which includes 3 matrixes. A 4D tensor is an array of 3D tensors or vector of cubes. A 5D tensor is an array of 4D tensors or matrix of cubes. In an illustrative example, the first tensor may be a vector of contiguous non-zero values, where the vector is a 1λN array, as illustrated, for example, by the dense tensor 304 of FIG. 3.

It is understood that a tensor need not be used. Rather, any suitable data structure can be used in place of a tensor as described herein. For example, machine learning models other than neural networks may perform work on other data structures that include sparse data, such as nodes of a tree, a graph, or the like. Accordingly, every instance of a “tensor” described herein can alternatively be swapped out with “data structure.”

It is also understood that “the least one zero value” of the second tensor or any zero value described herein need not be a “zero.” Rather, the zero can represent any sparse value. A “sparse value” as described herein refers to any value that does not represent actual data, such as a zero value in a tensor, an empty element (e.g. cell or field) in a tensor with no value, an “N/A” value in a tensor, a “null” (e.g., missing) value in the tensor, or the like. Even though sparse values typically refer to “0” values, which are different that missing (e.g., “null”) values, in some embodiments, sparse values include both “0” and missing values. In other embodiments, sparse values refer only to “0” values and not missing values or any other value.

In some embodiments, the second tensor is a sparse tensor among a plurality of non-sparse tensor. In this case, some embodiments select the second tensor for the condensing to the first tensor and also refrain from selecting any of the non-sparse tensors to condense into another tensor. For example, referring back to FIG. 3, only the sparse tensor 302 is selected for the conversion into the dense vector 304 but no other non-dense tensors (e.g., those tensors whose values include 49% or less sparse values) are selected or converted into dense tensors. As described herein, there is typically a high computation, memory storage, and latency cost of generating dense tensors. Accordingly, particular embodiments only generate dense tensors for those tensors that are sparse tensors but not generate dense tensors for any non-sparse tensor.

Per block 704, some embodiments derive shape data of the second tensor. To “derive” as described herein means to either “generate” or “receive.” For example, to generate shape data, some embodiments compute a shape of the second tensor (or the first tensor). For example, some embodiments calculate shape data based on a quantity of elements (e.g., cells or fields) in each axis of the second tensor. In some embodiments, such calculation or derivation thereof includes the functionality as described by the shape data generator 104 of FIG. 1 or the shape vector 406 of FIG. 4.

Per block 706, some embodiments derive a binary map (e.g., based on the second tensor), where each 0 bit in the binary map indicates a corresponding zero value in the second tensor and each 1 bit in the binary map indicates a corresponding non-zero value in the second tensor. In some embodiments, block 706 includes the functionality as described with respect to FIG. 5 and/or the binary map generator 106 of FIG. 1. In some embodiments, such binary map additionally stores or maintains position information (e.g., via the indices 520, 530, 510, and/or 512) of all the values in the second tensor in order to specifically indicate which value at each corresponding address (e.g., a particular row-column intersection) in the binary map is a zero or non-zero value.

Per block 708, based at least in part on the shape data and the binary map, some embodiments perform a neural network operation on the first tensor. A “neural network operation” as described herein refers to any suitable operation, such as a matrix multiplication operation (e.g., as described with respect to FIG. 6), an activation function, a dropout function, normalization, convolution, etc.

For example, referring back to FIG. 6, based on the shape data indicated in the shape vector 608, 612, and/or 616 and the binary map indicated in 610, 612, and/or 618, the dense tensor compute component 108 performs matrix multiplication on the dense tensor {5, 20, 5, 66} (e.g., the first tensor) by multiplying this dense tensor with the other dense tensor {2, 3, 7, 3} indicated in 614 to get the final output dense tensor as indicated in 618 (e.g., the output of the “neural network operation on the first tensor” described herein.

However, in order to arrive at such final output dense tensor, in some embodiments, the machine learning model, such as the shape propagate component 112, alternatively or additionally performs one or more other machine learning model operations, such as generating the shape tensor 608, 612, and/or 616, and/or generating the resulting binary map indicated in 618 (and/or the binary maps indicated in 610 and 614). In other words, in order for the final output tensor to be generated by the dense tensor compute component 108, in some embodiments, the dense tensor compute component 108 needs to use the shape vector 616 and binary map 11, 11, 10 as input (which is generated by the shape propagate component 112) so that it has reference to where the sparse values are in a tensor so that it can generate the output dense tensor (e.g., the dense tensor indicated in 618).

For example, some embodiments generate a second binary map of one bits and zero bits (e.g., the binary map indicated in 618 of FIG. 6), where the zero bits indicate the zero values in a second output tensor (e.g., the output tensor 606 of FIG. 6) and the one bits indicate non-zero values in the second output tensor. Based on the generating of the second binary map, some embodiments generate a first output tensor (e.g., the dense tensor indicated in 618 of FIG. 6) that is a condensed representation of the second output tensor associated with the second tensor, where the second output tensor includes zero values and the first output tensor does not include any zero values. Accordingly, the generating of the first output tensor is an output for the performing of the neural network operation on the first tensor at block 708.

In other words, in some embodiments, the performing of the neural network operation (either on the first tensor or other tensors) results in a first output tensor (e.g., the dense tensor in 618 of FIG. 6) that is a condensed representation of a second output tensor (e.g., the output tensor 606) associated with the second tensor (e.g., it is a product result of multiplying 602 by 604). The second output tensor includes zero values and the first output tensor does not include any zero values. Additionally or alternatively, some embodiments generate final shape data (e.g., the shape vector 616). And the first output tensor is further generated based on the final shape data, as illustrated in FIG. 6, for example. In some embodiments, the performing of the neural network operation results in generating a second binary map (e.g., the binary map 11, 11, 10 indicated in 618) of one bits and zero bits, where the zero bits indicate the zero values in the second output tensor (e.g., 606) and the one bits indicate non-zero values in the second output tensor.

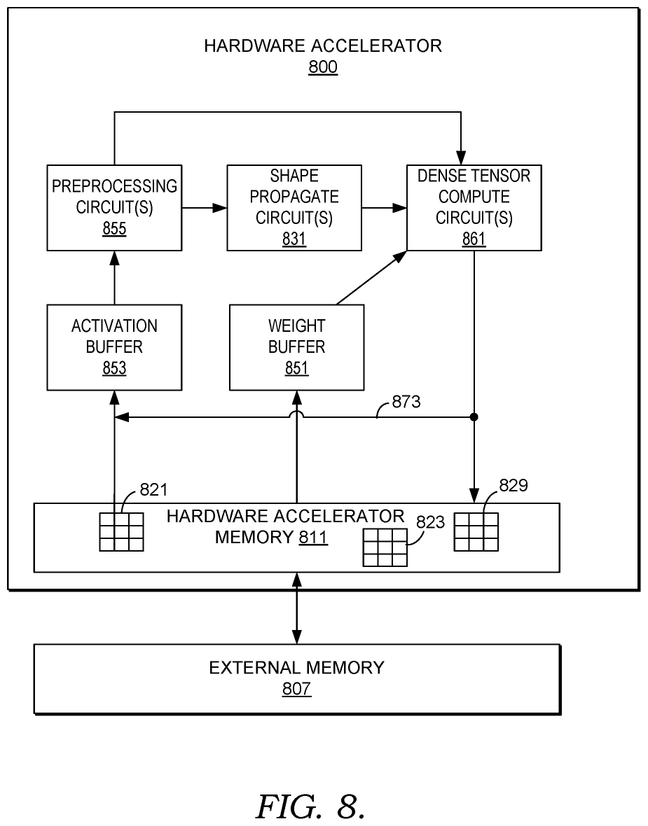

FIG. 8 is a block diagram illustrating circuitry and hardware architecture of an example hardware accelerator 800, according to some embodiments. In some embodiments, the hardware accelerator 800 is an AI hardware accelerator that includes one or more a circuits for performing operations related to neural networks. In some embodiments, the hardware accelerator 800 is part of a larger processor, such as a CPU. In other embodiments, the hardware accelerator 800 is a part of other components described herein, such as a Graphics Processing Unit (GPU), field programmable gate arrays (FPGA), application-specific integrated circuits (ASIC), or a Tensor Processing Unit (TPU). The hardware accelerator 800 includes hardware accelerator memory 811.

In some embodiments, the hardware accelerator memory 811 is used for storage of data fetched from external memory 807. The data stored in hardware acceleration memory 811 may include input data of neural network 200, weights and other coefficients in neural network 200, intermediate data of neural network 200, such as output activation tensor 222 that is outputted by the node 210, loss function coefficients, and other suitable data that are related to the operation of neural network 200. For each node (e.g., as illustrated in FIG. 2), such as node 210, input activation tensor 821 is stored to hardware accelerator memory 811. After the operations of the each node in a neural network (such as each node indicated in FIG. 2) in a layer of neural network 200 are completed, operations of nodes in the next layer may begin. The output activation tensor 829 is then fetched again as the input activation tensor 821 of a succeeding node in the next layer. The process repeats until the operations reach the output layer (e.g., the output layer 204). In some embodiments, the data stored in hardware accelerator memory 811 is sparse tensors or dense tensors. In some embodiments, the hardware accelerator 800 does not include hardware accelerator memory 811. Instead, data are directly fetched and written to and read from the external memory 807. External memory 807 is storage space outside of the hardware accelerator 800, such as processor cache (L1, L2, or L3), main memory (e.g., RAM), or disk. Hardware accelerator memory 811 is dedicated memory (e.g., cache) that only the hardware accelerator 800 uses and no other component of a computing device. In this way, hardware accelerator memory 811 can reduce latency because it is dedicated and near the circuitry components of the hardware accelerator 800.

The input activation tensor 821 (e.g., the input tensor 220 of FIG. 1) and the weight tensor 823 are first accessed from the hardware accelerator memory 811 (or the external memory 807) and respectively placed in the activation buffer 853 and weight buffer 851. Activation buffer 853 passes the input activation tensor 821 to the preprocessing circuit(s) 855. In some embodiments, the activation buffer 853 is a buffer circuit and related data-processing circuit for performing data processing on the input activation tensor 821 (e.g., for node 210). For example, the input activation tensor 821 may have a size that is significantly larger than the capacity than the dense tensor compute circuit(s) 861 can perform work on. The input activation tensor 821 may be divided, via the activation buffer 853, into multiple data subunits and be processed in parallel by different dense tensor compute circuit(s) 861. Activation buffer 853 may include circuitry that divides the input activation tensor 821 or include different addresses for various dense tensor compute circuit(s) 861 to fetch different portions of the input activation tensor 821. In some embodiments, activation buffer 853 may fetch the tensor values from hardware accelerator memory 811. In some cases, only the non-sparse values are fetched from the activation buffer 853.

In some embodiments, the activation buffer 853 performs a transpose operation of the input activation tensor 821 by fetching data values in the input activation tensor 821 in an order different from the hardware accelerator memory 811. In some cases, an input activation tensor 821 is stored to the hardware accelerator memory 811 under certain dimensions such as X by Y by Z while the division of data subunits may be more efficient under the dimension Y by Z by X. The efficiency of storage and operation of data under certain dimensions may depend on the hardware landscape such as the multiplier arrangement in the dense tensor compute circuit(s) 861 and memory structure.

The weight buffer 851 passes the weight tensor 823 directly to the dense tensor compute circuit(s) 861 since, in some embodiments, the preprocessing circuit(s) 855 are concerned only with activation sparsity (sparse values in activation tensors), as opposed to weight sparsity (sparse values in weight tensors). However, in other embodiments, the weight buffer 851 alternatively or additionally passes the weight tensor 823 to the preprocessing circuit(s) 855. A weight buffer 851 and preprocessing circuit(s) 855 are other examples of circuitry upstream of the shape propagate circuit(s) 831 and dense tensor compute circuit(s) 861 for pre-processing of various tensors. For an operation with respect to a given node (e.g., node 210) in a neural network, weight buffer 851 fetches the tensor values of weight tensor 823 from hardware accelerator memory 811 or external memory 807. Similar to activation buffer 853, in some cases weight buffer 351 may only fetch the non-zero values in weight tensor 823.

The preprocessing circuit(s) 855 is configured for pre-processing the input activation tensor 821. In other words, the preprocessing circuit(s) 855 modify or change the input activation tensor 821 in some way before computations begin at the shape propagate circuit(s) 831 and the dense tensor compute circuit(s) 861. For example, in some embodiments, the preprocessing circuit(s) 855 include the dense tensor generator 102, the shape data generator 104 and/or the binary map generator 106 as described in FIG. 1 (which may each be respective circuits). That is, in some embodiments, the preprocessing circuit(s) 855 generates a dense tensor that represents the input activation tensor 821 (which may represent a sparse tensor), generates shape data of the input activation tensor 821 and/or generates a binary map representing the sparse and non-sparse values within the input activation tensor 821.

In some embodiments, the preprocessing circuit(s) 855 is additionally configured for identifying locations of sparse and/or non-sparse values in the input activation tensor 821 (and/or weight tensor 823). The preprocessing circuit(s) 855 may scan through the input activation tensor 821 and identify the locations of the sparse and/or non-sparse values in the input activation tensor 821. The locations may take the form of the locations in the tensor (e.g., a location at the third row and the fifth column in the tensor) and may also take the form of memory addresses of active values (e.g., an active value being saved in the memory address of 0xC0010000).

In some embodiments, the preprocessing circuit(s) 855 performs other data pre-processing such as transposing weight tensor 823 and input activation tensor 821. Preprocessing circuit(s) 855 may also divide the tensors in a way that is efficient for the shape propagate circuit(s) and the dense tensor compute circuit(s) 861 to process.

As illustrated in FIG. 8, the pre-processed tensor 820 is sent, in parallel, to the dense tensor compute circuit(s) 861, as well as the shape propagate circuit(s) 831, to perform computations with input activation tensor 221. In some embodiments, however, the dense tensor compute circuit(s) 861 waits for a control signal or other communication from the shape propagate circuit(s) 831 to begin operating on the dense tensor(s) (preprocessed by the preprocessing circuit(s) 855). This is because, in some embodiments, in order to generate a final dense tensor (e.g., a dot product of multiplying two dense tensors), the dense tensor compute circuit(s) 861 may need shape data and binary maps created by the shape propagate circuit(s) 831.

In some embodiments, where the input activation tensor 821 is not a sparse tensor (e.g., only has 10 percent of zero values), after processing by the preprocessing circuit(s) 855, the preprocessing circuit(s) 855 passes the input activation tensor 821 to a separate circuit (not shown), which performs typical neural network operation on non-dense tensors, such as matrix multiplication, activation functions, normalization, or the like.

The shape propagate circuit(s) 831 is configured to take the binary element location of all sparse and/or non-sparse values (e.g., the binary map generated by the binary map generator 106) as well as the shape data (e.g., as calculated by the shape data generator 104) to generate the sparse location information associated with the output activation tensor 829 produced by the dense tensor compute circuit(s) 861. For example, referring back to FIG. 6, the shape propagate circuit(s) 831 may generate the binary map 11, 11, 10 as indicated in 618 via multiplying the binary maps indicated in 610 and 614. The shape propagate circuit(s) 831 may additionally or alternatively generate the shape vector 616 by multiplying the shape vector 608 and 612.

The dense tensor compute circuit(s) 861 is generally configured for performing one or more neural network operations (e.g., matrix multiplication.) on the dense tensors generated by the preprocessing circuit(s) 855. In order to do this, as illustrated in FIG. 8, the dense tensor compute circuit(s) 861 takes, as input, the final binary map and/or shape map produced by the shape propagate circuit(s) 831, the weight tensor 822 from the weight buffer 850, as well as the dense tensors produced by the preprocessing circuit(s) 855 to perform a neural network operation. For example, regarding matrix multiplication, the dense tensor compute circuit(s) 861 may multiply the weight tensor 823 (or a preprocessed version without zeros) by a dense tensor generated by the preprocessing circuit(s) 855, while using the output from the shape propagate circuit(s) 831 (i.e., an indication of where the sparse and non-sparse values are), to generate a dot product or other output. In some embodiments, the dense tensor compute circuit(s) 861 represents or includes the functionality as described with respect to the dense tensor compute component 108 of FIG. 1.

The dense tensor compute circuit(s) 861 and/or the shape propagate circuit(s) 831 may take various forms. In some embodiments, the dense tensor compute circuit(s) 861 and/or the shape propagate circuit(s) 831 includes a multiply-accumulate circuit (MAC) that includes multiply units and accumulators. The multiply units may be used to perform multiplications and additions. A multiply unit is a circuit with a known structure and may be used for binary multiplication or floating-point multiplication. An accumulator is a memory circuit that receives and stores values from the multiply units. The values may be stored individually or added together in the accumulator.

As illustrated in FIG. 8, the output of the dense tensor compute circuit(s) 861 is that it generates the output activation tensor 829 (e.g., from an intermediate output tensor). For example, the output activation tensor 829 can represent the output dense tensor represented in 618 of FIG. 6. The dene tensor compute circuit(s) 861 may set a number of values in the intermediate output tensor to zero, depending on the type of activation function, for example. Hence, output activation tensor 229 may be a dense tensor or any other suitable tensor. Output activation tensor 829 is transmitted to hardware accelerator memory 811 or external memory 807 as the output of a particular node, such as 210 of FIG. 2. In some embodiments, the output activation tensor 829 may also directly be fed back to activation buffer 853 as the input of the next cycle, as indicated by arrow 873. The output activation tensor 829 is fetched subsequently as an input activation tensor 821 when another round of operations related to a subsequent node begins.

Embodiments of the disclosure may be described in the general context of computer code or machine-useable instructions, including computer-useable or computer-executable instructions, such as program modules, being executed by a computer or other machine, such as a smartphone, a tablet PC, or other mobile device, server, or client device. Generally, program modules, including routines, programs, objects, components, data structures, and the like, refer to code that performs particular tasks or implements particular abstract data types. Embodiments of the disclosure may be practiced in a variety of system configurations, including mobile devices, consumer electronics, general-purpose computers, more specialty computing devices, or the like. Embodiments of the disclosure may also be practiced in distributed computing environments where tasks are performed by remote-processing devices that are linked through a communications network. In a distributed computing environment, program modules may be located in both local and remote computer storage media including memory storage devices.

Some embodiments may comprise an end-to-end software-based system that can operate within system components described herein to operate computer hardware to provide system functionality. At a low level, hardware processors may execute instructions selected from a machine language (also referred to as machine code or native) instruction set for a given processor. The processor recognizes the native instructions and performs corresponding low level functions relating, for example, to logic, control and memory operations. Low level software written in machine code can provide more complex functionality to higher levels of software. Accordingly, in some embodiments, computer-executable instructions may include any software, including low level software written in machine code, higher level software such as application software and any combination thereof. In this regard, the system components can manage resources and provide services for system functionality. Any other variations and combinations thereof are contemplated with embodiments of the present disclosure.

### OTHER EMBODIMENTS

Some embodiments are directed to a system comprising: a hardware accelerator that includes one or more circuitry components configured for the following operations: receiving a first tensor, the first tensor being a condensed representation of a second tensor, the second tensor including at least one zero value and the first tensor not including any zero values; deriving shape data of the second tensor; deriving a binary map, each zero bit in the binary map indicating a corresponding zero value in the second tensor, each one bit in the binary map indicating a corresponding non-zero value in the second tensor; and based at least in part on the shape data and the binary map, performing a neural network operation on the first tensor.

Advantageously, these and other embodiments of the system, as described herein, have the technical effects of improved hardware consumption via computer storage reduction, power reduction, and I/O reduction. These and other embodiments have the technical effect of computing resource consumption via reduced model inference latency and reduced cycle processing, as described herein. These and other embodiments have the technical effect of eliminating wear on certain hardware components, such as a Central Processing Unit (CPU) (e.g., via a hardware accelerator) and also improve existing technologies, as described herein.

In any combination of the above embodiments of the system, the one or more circuitry components are included in one of: a Graphics Processing Unit (GPU), a field programmable gate array (FPGA), an application-specific integrated circuit (ASIC), or a Tensor Processing Unit (TPU), and wherein the hardware accelerator excludes a Central Processing Unit (CPU).

In any combination of the above embodiments of the system, the first tensor is a vector of contiguous non-zero values, the vector being a 1×N array, and wherein the first tensor is generated by transferring all non-zero values in the second tensor to the first tensor.

In any combination of the above embodiments of the system, the shape data is calculated based on a quantity of values in each axis of the second tensor.

In any combination of the above embodiments of the system, the one or more circuitry components are further configured for: generating a second binary map of one bits and zero bits, the zero bits indicate the zero values in a second output tensor and the one bits indicate non-zero values in the second output tensor; based on the generating of the second binary map, generating a first output tensor that is a condensed representation of the second output tensor associated with the second tensor, and wherein the second output tensor includes zero values and the first output tensor does not include any zero values, and wherein the generating of the first output tensor is an output for the performing of the neural network operation on the first tensor.

In any combination of the above embodiments of the system, the second tensor is a sparse tensor among a plurality of non-sparse tensors, and wherein the one or more circuitry components are further configured for: selecting the second tensor for the condensing to the first tensor, and refraining from selecting any of the non-sparse tensors to condense into another tensor.

In any combination of the above embodiments of the system, the neural network operation is performed via a Large Language Model (LLM).

Various embodiments are directed to a computer-implemented method comprising the following operations: receiving a first tensor, the first tensor including a plurality sparse values; generating a second tensor that represents a condensed version of the first tensor without the plurality of sparse values; computing a shape of the first tensor; based at least in part on the first tensor, generating a binary map, each zero bit in the binary map indicating a corresponding position of a sparse value in the first tensor, each one bit in the binary map indicating a corresponding position of a non-sparse value in the first tensor; and based at least in part on the second tensor, the shape of the first tensor, and the binary map, performing a machine learning model operation.

Advantageously, these and other embodiments of this computer-implemented method, as described herein, have the technical effects of improved hardware consumption via computer storage reduction, power reduction, and I/O reduction. These and other embodiments have the technical effect of computing resource consumption via reduced model inference latency and reduced cycle processing, as described herein. These and other embodiments have the technical effect of eliminating wear on certain hardware components, such as a Central Processing Unit (CPU) (e.g., via a hardware accelerator) and also improve existing technologies, as described herein.

In any combination of the above embodiments of the computer-implemented method, the computer-implemented method is performed by one of: a Central Processing Unit (CPU) or a hardware accelerator.

In any combination of the above embodiments of the computer-implemented method, the second tensor is a vector of contiguous non-zero values, the vector being a 1×N array, and wherein the second tensor is generated by transferring all non-zero values in the first tensor to the second tensor.

In any combination of the above embodiments of the computer-implemented method, the shape data is computed based on a quantity of values in each axis of the first tensor.

In any combination of the above embodiments of the computer-implemented method, the computer-implemented method further comprises: generating a second binary map of one bits and zero bits, the zero bits indicate the sparse values in a second output tensor and the one bits indicate non-sparse values in the second output tensor; generating final shape data; and based on the generating of the second binary map and the final shape data, generating a first output tensor that is a condensed representation of the second output tensor associated with the first tensor, and wherein the second output tensor includes sparse values and the first output tensor does not include any sparse values, and wherein the generating of the first output tensor is an output for the performing of the machine learning operation.

In any combination of the above embodiments of the computer-implemented method, the first tensor is a sparse tensor among a plurality of non-sparse tensors, and wherein method further comprises selecting the first tensor for the condensing to the second tensor, and refraining from selecting any of the non-sparse tensors to condense into another tensor.

In any combination of the above embodiments of the computer-implemented method, the performing of the machine learning operation is performed via a Large Language Model (LLM).

Various embodiments are directed to a method comprising: receiving a first data structure, the first data structure being a condensed representation of a second data structure, the second data structure including at least one sparse value and the first data structure not including any sparse values; deriving shape data of the second data structure; and based at least in part on using the first data structure and the shape data as input, performing a machine learning model operation on the first data structure but not the second data structure.

Advantageously, these and other embodiments of this method, as described herein, have the technical effects of improved hardware consumption via computer storage reduction, power reduction, and I/O reduction. These and other embodiments have the technical effect of computing resource consumption via reduced model inference latency and reduced cycle processing, as described herein. These and other embodiments have the technical effect of eliminating wear on certain hardware components, such as a Central Processing Unit (CPU) (e.g., via a hardware accelerator) and also improve existing technologies, as described herein.

In any combination of the above embodiments of the method, the method is performed by one of: a Central Processing Unit (CPU) or a hardware accelerator.

In any combination of the above embodiments of the method, the first data structure is a vector of contiguous non-zero values, the vector being a 1×N array, and wherein the first data structure is generated by transferring all non-zero values in the second data structure to the first data structure.

In any combination of the above embodiments of the method, the shape data is computed based on a quantity of values in each axis of the second data structure.

In any combination of the above embodiments of the method, the method further comprising: generating a binary map, each zero bit in the binary map indicating a corresponding position of a sparse value in the second data structure, each one bit in the binary map indicating a corresponding position of a non-sparse value in the second data structure, wherein the performing of the machine learning operation is further based on the generating of the binary map.

In any combination of the above embodiments of the method, the method further comprising: generating a second binary map of one bits and zero bits, the zero bits indicate the sparse values in a second output data structure and the one bits indicate non-sparse values in the second output data structure; and based on the generating of the second binary map, generating a first output data structure that is a condensed representation of the second output data structure associated with the second data structure, and wherein the second output data structure includes sparse values and the first output data structure does not include any sparse values, and wherein the generating of the first output data structure is an output for the performing of the machine learning operation on the first data structure.

### Example Computing Architecture and Device

Turning now to FIG. 9, a block diagram is provided showing an example operating environment 10 in which some embodiments of the present disclosure may be employed. It should be understood that this and other arrangements described herein are set forth only as examples. Other arrangements and elements (for example, machines, interfaces, functions, orders, and groupings of functions) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by an entity may be carried out by hardware, firmware, and/or software. For instance, some functions may be carried out by a processor executing instructions stored in memory.

Among other components not shown, example operating environment 10 includes a number of user devices, such as user devices 02a and 02b through 02n; a number of data sources (for example, databases or other data stores, such as 105), such as data sources 04a and 04b through 04n; server 06; sensors 03a and 07; and network(s) 110. It should be understood that environment 10 shown in FIG. 9 is an example of one suitable operating environment. Each of the components shown in FIG. 9 may be implemented via any type of computing device, such as computing device 11 as described in connection to FIG. 10, for example. These components may communicate with each other via network(s) 110, which may include, without limitation, a local area network (LAN) and/or a wide area networks (WAN). In some implementations, network(s) 110 comprises the Internet and/or a cellular network, amongst any of a variety of possible public and/or private networks.

It should be understood that any number of user devices, servers, and data sources may be employed within operating environment 10 within the scope of the present disclosure. Each may comprise a single device or multiple devices cooperating in a distributed environment. For instance, server 06 may be provided via multiple devices arranged in a distributed environment that collectively provide the functionality described herein. Additionally, other components not shown may also be included within the distributed environment.

User devices 02a and 02b through 02n can be client devices on the client-side of operating environment 10, while server 06 can be on the server-side of operating environment 10. Server 06 can comprise server-side software designed to work in conjunction with client-side software on user devices 02a and 02b through 02n so as to implement any combination of the features and functionalities discussed in the present disclosure. This division of operating environment 10 is provided to illustrate one example of a suitable environment, and there is no requirement for each implementation that any combination of server 06 and user devices 02a and 02b through 02n remain as separate entities. In some embodiments, the one or more servers 06 represent one or more nodes in a cloud computing environment. Consistent with various embodiments, a cloud computing environment includes a network-based, distributed data processing system that provides one or more cloud computing services. Further, a cloud computing environment can include many computers, hundreds or thousands of them or more, disposed within one or more data centers and configured to share resources over the one or more network(s) 110.

In some embodiments, a user device 02a or server 06 alternatively or additionally comprises one or more web servers and/or application servers to facilitate delivering web or online content to browsers installed on a user device 02b. Often the content may include static content and dynamic content. When a client application, such as a web browser, requests a website or web application via a URL or search term, the browser typically contacts a web server to request static content or the basic components of a website or web application (for example, HTML pages, image files, video files, and the like). Application servers typically deliver any dynamic portions of web applications or business logic portions of web applications. Business logic can be described as functionality that manages communication between a user device and a data store (for example, a database). Such functionality can include business rules or workflows (for example, code that indicates conditional if/then statements, while statements, and the like to denote an order of processes).

User devices 02a and 02b through 02n may comprise any type of computing device capable of use by a user. For example, in one embodiment, user devices 02a through 02n may be the type of computing device described in relation to FIG. 10 herein. By way of example and not limitation, a user device may be embodied as a personal computer (PC), a laptop computer, a mobile phone or mobile device, a smartphone, a tablet computer, a smart watch, a wearable computer, a personal digital assistant (PDA), a music player or an MP3 player, a global positioning system (GPS) or device, a video player, a handheld communications device, a gaming device or system, an entertainment system, a vehicle computer system, an embedded system controller, a camera, a remote control, a bar code scanner, a computerized measuring device, an appliance, a consumer electronic device, a workstation, or any combination of these delineated devices, or any other suitable computer device.

Data sources 04a and 04b through 04n may comprise data sources and/or data systems, which are configured to make data available to any of the various constituents of operating environment 10 or system 100 described in connection to FIG. 1. Examples of data source(s) 04a through 04n may be one or more of a database, a file, data structure, corpus, or other data store. Data sources 04a and 04b through 04n may be discrete from user devices 02a and 02b through 02n and server 06 or may be incorporated and/or integrated into at least one of those components. In one embodiment, data sources 04a through 04n comprise sensors (such as sensors 03a and 07), which may be integrated into or associated with the user device(s) 02a, 02b, or 02n or server 06.

In some embodiments, operating environment 10 is utilized to implement one or more of the components of the system 100, described in FIG. 1, including components for generating a score indicating whether a same user accessed multiple sessions, as described herein. Operating environment 10 also can be utilized for implementing aspects of processes 700 (FIG. 7), and/or any other functionality as described in connection with FIGS. 1-8

Having described various implementations, an exemplary computing environment suitable for implementing embodiments of the disclosure is now described. With reference to FIG. 10, an exemplary computing device is provided and referred to generally as computing device 11. The computing device 11 is but one example of a suitable computing environment and is not intended to suggest any limitation as to the scope of use or functionality of embodiments of the disclosure. Neither should the computing device 11 be interpreted as having any dependency or requirement relating to any one or combination of components illustrated.

Turning to FIG. 10, computing device 11 includes a bus 19 that directly or indirectly couples the following devices: memory 12, one or more processors 14, one or more presentation components 16, one or more input/output (I/O) ports 18, one or more I/O components 20, an illustrative power supply 22, and a hardware accelerator 26. Bus 19 represents what may be one or more busses (such as an address bus, data bus, or combination thereof). Although the various blocks of FIG. 10 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 10 is merely illustrative of an exemplary computing device that can be used in connection with one or more embodiments of the present disclosure. Distinction is not made between such categories as “workstation,” “server,” “laptop,” “handheld device,” or other computing device, as all are contemplated within the scope of FIG. 10 and with reference to “computing device.”

Computing device 11 typically includes a variety of computer-readable media. Computer-readable media can be any available media that can be accessed by computing device 11 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 11. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 12 includes computer storage media in the form of volatile and/or nonvolatile memory. The memory may be removable, non-removable, or a combination thereof. Exemplary hardware devices include solid-state memory, hard drives, optical-disc drives, or other hardware. Computing device 11 includes one or more processors 14 that read data from various entities such as memory 12 or I/O components 20. Presentation component(s) 16 presents data indications to a user or other device. Exemplary presentation components include a display device, speaker, printing component, vibrating component, and the like.

The I/O ports 18 allow computing device 11 to be logically coupled to other devices, including I/O components 20, some of which may be built in. Illustrative components include a microphone, joystick, game pad, satellite dish, scanner, printer, wireless device, and the like. The I/O components 20 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 11. The computing device 11 may be equipped with depth cameras, such as stereoscopic camera systems, infrared camera systems, RGB camera systems, and combinations of these, for gesture detection and recognition. Additionally, the computing device 11 may be equipped with accelerometers or gyroscopes that enable detection of motion. The output of the accelerometers or gyroscopes may be provided to the display of the computing device 11 to render immersive augmented reality or virtual reality.

Some embodiments of computing device 11 may include one or more radio(s) 24 (or similar wireless communication components). The radio 24 transmits and receives radio or wireless communications. The computing device 11 may be a wireless terminal adapted to receive communications and media over various wireless networks. Computing device 11 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include, by way of example and not limitation, a Wi-Fi® connection to a device (for example, mobile hotspot) that provides access to a wireless communications network, such as a WLAN connection using the 802.11 protocol, a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Hardware accelerator 26 represents any suitable hardware component (e.g., GPU) that offloads one or more tasks (e.g., from a CPU) to accelerate or speed up the task. In some embodiments, the hardware accelerator 26 represents a Graphics Processing Unit (GPU), field programmable gate arrays (FPGA), application-specific integrated circuits (ASIC), a Tensor Processing Unit (TPU), a sound card, or any suitable hardware component. In some embodiments, the hardware accelerator 26 represents the hardware accelerator 800 of FIG. 8.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (for example, machines, interfaces, functions, orders, and groupings of functions, and the like.) can be used in addition to or instead of those shown.

Embodiments of the present disclosure have been described with the intent to be illustrative rather than restrictive. Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

As used herein, the term “set” may be employed to refer to an ordered (i.e., sequential) or an unordered (i.e., non-sequential) collection of objects (or elements), such as but not limited to data elements (for example, events, clusters of events, and the like). A set may include N elements, where N is any non-negative integer. That is, a set may include 1, 2, 3, . . . . N objects and/or elements, where N is an positive integer with no upper bound. Therefore, as used herein, a set may include only a single element. In other embodiments, a set may include a number of elements that is significantly greater than one, two, or three elements. As used herein, the term “subset,” is a set that is included in another set. A subset may be, but is not required to be, a proper or strict subset of the other set that the subset is included in. That is, if set B is a subset of set A, then in some embodiments, set B is a proper or strict subset of set A. In other embodiments, set B is a subset of set A, but not a proper or a strict subset of set A.

The invention claimed is:

1. A system comprising: a hardware accelerator that includes one or more circuitry components configured for:
receiving a first tensor, the first tensor being a condensed representation of a second tensor, the second tensor including at least one zero value and the first tensor not including any zero values;
deriving shape data of the second tensor;
deriving a binary map, each zero bit in the binary map indicating a corresponding zero value in the second tensor, each one bit in the binary map indicating a corresponding non-zero value in the second tensor; and
based at least in part on the shape data and the binary map, performing a neural network operation on the first tensor.

2. The system of claim 1, wherein the one or more circuitry components are included in one of: a Graphics Processing Unit (GPU), a field programmable gate array (FPGA), an application-specific integrated circuit (ASIC), or a Tensor Processing Unit (TPU), and wherein the hardware accelerator excludes a Central Processing Unit (CPU).

3. The system of claim 1, wherein the first tensor is a vector of contiguous non-zero values, the vector being a 1×N array, and wherein the first tensor is generated by transferring all non-zero values in the second tensor to the first tensor.

4. The system of claim 1, wherein the shape data is calculated based on a quantity of values in each axis of the second tensor.

5. The system of claim 1, wherein the one or more circuitry components are further configured for:
generating a second binary map of one bits and zero bits, the zero bits indicate the zero values in a second output tensor and the one bits indicate non-zero values in the second output tensor;
based on the generating of the second binary map, generating a first output tensor that is a condensed representation of the second output tensor associated with the second tensor, and wherein the second output tensor includes zero values and the first output tensor does not include any zero values, and wherein the generating of the first output tensor is an output for the performing of the neural network operation on the first tensor.

6. The system of claim 1, wherein the second tensor is a sparse tensor among a plurality of non-sparse tensors, and wherein the one or more circuitry components are further configured for: selecting the second tensor for the condensing to the first tensor, and refraining from selecting any of the non-sparse tensors to condense into another tensor.

7. The system of claim 1, wherein the neural network operation is performed via a Large Language Model (LLM).

8. A computer-implemented method comprising:
receiving a first tensor, the first tensor including a plurality sparse values;
generating a second tensor that represents a condensed version of the first tensor without the plurality of sparse values;
computing a shape of the first tensor;
based at least in part on the first tensor, generating a binary map, each zero bit in the binary map indicating a corresponding position of a sparse value in the first tensor, each one bit in the binary map indicating a corresponding position of a non-sparse value in the first tensor; and
based at least in part on the second tensor, the shape of the first tensor, and the binary map, performing a machine learning model operation.

9. The computer-implemented method of claim 8, wherein the method is performed by one of: a Central Processing Unit (CPU) or a hardware accelerator.

10. The computer-implemented method of claim 8, wherein the second tensor is a vector of contiguous non-zero values, the vector being a 1×N array, and wherein the second tensor is generated by transferring all non-zero values in the first tensor to the second tensor.

11. The computer-implemented method of claim 8, wherein the shape data is computed based on a quantity of values in each axis of the first tensor.

12. The computer-implemented method of claim 8, further comprising:
generating a second binary map of one bits and zero bits, the zero bits indicate the sparse values in a second output tensor and the one bits indicate non-sparse values in the second output tensor;
generating final shape data; and
based on the generating of the second binary map and the final shape data, generating a first output tensor that is a condensed representation of the second output tensor associated with the first tensor, and wherein the second output tensor includes sparse values and the first output tensor does not include any sparse values, and wherein the generating of the first output tensor is an output for the performing of the machine learning operation.

13. The computer-implemented method of claim 8, wherein the first tensor is a sparse tensor among a plurality of non-sparse tensors, and wherein method further comprises selecting the first tensor for the condensing to the second tensor, and refraining from selecting any of the non-sparse tensors to condense into another tensor.

14. The computer-implemented method of claim 8, wherein the performing of the machine learning operation is performed via a Large Language Model (LLM).

15. A method comprising:
receiving a first data structure, the first data structure being a condensed representation of a second data structure, the second data structure including at least one sparse value and the first data structure not including any sparse values;
deriving shape data of the second data structure; and
based at least in part on using the first data structure and the shape data as input, performing a machine learning model operation on the first data structure but not the second data structure.

16. The method of claim 15, wherein the method is performed by one of: a Central Processing Unit (CPU) or a hardware accelerator.

17. The method of claim 15, wherein the first data structure is a vector of contiguous non-zero values, the vector being a 1×N array, and wherein the first data structure is generated by transferring all non-zero values in the second data structure to the first data structure.

18. The method of claim 15, wherein the shape data is computed based on a quantity of values in each axis of the second data structure.

19. The method of claim 15, further comprising:
generating a binary map, each zero bit in the binary map indicating a corresponding position of a sparse value in the second data structure, each one bit in the binary map indicating a corresponding position of a non-sparse value in the second data structure, wherein the performing of the machine learning operation is further based on the generating of the binary map.

20. The method of claim 19, further comprising:
generating a second binary map of one bits and zero bits, the zero bits indicate the sparse values in a second output data structure and the one bits indicate non-sparse values in the second output data structure; and
based on the generating of the second binary map, generating a first output data structure that is a condensed representation of the second output data structure associated with the second data structure, and wherein the second output data structure includes sparse values and the first output data structure does not include any sparse values, and wherein the generating of the first output data structure is an output for the performing of the machine learning operation on the first data structure.
